(19) United States
(12) Patent Application Publication
(10) Pub. No.: US 2008/0082613 A1
(43) Pub. Date: Apr. 3, 2008

(54) COMMUNICATING ONLINE PRESENCE AND MOOD

(75) Inventors: Christopher T. Szeto, Sunnyvale, CA (US); Mehul Kirtikant Sanghavi, Sunnyvale, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/536,469

(22) Filed: Sep. 28, 2006

(51) Int. Cl. G06F 15/16

(52) U.S. Cl. 709/206

(57) ABSTRACT

Methods and apparatus are described for communicating an online presence of a first user in a network. An online presence indicator is presented in a first interface associated with the first user. The online presence indicator represents an online status of the first user as being online or offline. The online presence indicator further represents a mood of the first user. At least one control is provided in the first interface which is operable by the first user to select the online status represented by the online presence indicator. The at least one control is further operable by the first user to select the mood represented by the online presence indicator. The online presence indicator of the first user is presented to other users in the network.

### BACKGROUND OF THE INVENTION

The present invention relates to communicating the online status of users in a network and, in particular, to techniques for enabling users to update and manage their status, and for integrating additional information into online status.

Messaging systems on the Web or mobile networks often provide some mechanism by which a user can indicate his current status to others on the network. An example of such a mechanism (illustrated in FIG. 1) is provided in messaging interface 100 of the popular Yahoo! Messenger application created by Yahoo! Inc. of Sunnyvale, Calif. As shown at 102, an icon (i.e., a “smiley face” in this example) and an associated status designation (i.e., “Available”) are associated with the user's screen name. This indicates the user's current online status to the user himself. And as illustrated in 104, this “online presence indicator” or OPI may also be represented in the contact lists of other users in the system to whom the user has elected to be visible, e.g., in whose address books the user is included.

In the messaging interface shown, the user can access a status menu (e.g., menu 106) which provides a number of options for controlling the user's online presence. That is, by selecting one of the available options the user can change the online presence indicator in his own messaging interface and the contact lists of the other users. In the example shown, a yellow smiley face indicates that the corresponding user is online, while a grey “sleepy” face indicates that the user is offline. As indicated in menu 106, there are a number of possible online states from which the user may select. The yellow smiley face without any associated symbols indicates the user is currently available.

Alternatively, a “busy” symbol or “badge” may be associated with or overlaid on the yellow smiley face to indicate that the user, while online, is currently busy with something else. As shown in menu 106, a number of default options may be provided which indicate common reasons for being busy, e.g., “Not at My Desk,” or “On the Phone.” The user may also create his own “busy” options by selecting the “New Status Message . . . ” option and entering appropriate text when prompted. Other badges include, for example, a cell phone icon which indicates that the user is mobile, and a clock icon which indicates that the user is currently idle.

In the current version of Yahoo! Messenger, users may elect to present an image or an avatar in place of the yellow smiley face. In such cases, the user's selected image or avatar is presented both in his own interface as well as in the contacts lists of other users. Unfortunately, while many users take advantage of this option to personalize their interface. It makes it more difficult to visually determine whether the corresponding user is online or offline. That is, the transition from the yellow smiley face to the grey sleeping face makes the user's online status readily apparent without referring to the associated text. However, the images or avatars used in place of the default online presence indicator remain the same in the Messenger interface whether the user is online or offline. That is, they do not themselves represent the user's online status. This forces users to refer to and rely on the associated text to determine online status.

A recent phenomenon on the Web and in mobile networks is the ability of users to use symbols and shorthand to communicate certain types of personal information. One example of such personal information is the current mood of a user. For example, Odigo (www.odigo.com) is an instant messaging service which allows users to select and communicate their current mood to other users of the service. imood (www.imood.com) is a web-based social networking service which enables its users to communicate their current moods to their friends. Yahoo! users also have some ability to communicate mood using avatars. However, widespread use of this capability has not yet occurred likely due to the fact that represented moods are difficult to discern in small images, and the fact that changing the represented mood is relatively burdensome.

Despite the various available mechanisms for communicating online presence and other personal information, it is desirable to provide techniques by which users can more effectively communicate such information.

### SUMMARY OF THE INVENTION

According to the present invention, methods and apparatus are provided for communicating an online presence of a first user in a network. An online presence indicator is presented in a first interface associated with the first user. The online presence indicator represents an online status of the first user as being online or offline. The online presence indicator further represents a mood of the first user. At least one control is provided in the first interface which is operable by the first user to select the online status represented by the online presence indicator. The at least one control is further operable by the first user to select the mood represented by the online presence indicator. The online presence indicator of the first user is presented to other users in the network.

A further understanding of the nature and advantages of the present invention may be realized by reference to the remaining portions of the specification and the drawings.

### BRIEF DESCRIPTION OF THE DRAWINGS

FIG. 1 illustrates an exemplary messaging interface according to the prior art.

FIG. 2 illustrates some examples of online presence indicators implemented according to specific embodiments the present invention.

FIG. 3 illustrates selection of an online presence indicator according to a specific embodiment of the invention.

FIGS. 4A, 4B, and 5 illustrate examples of how online presence indicators may be presented in exemplary interfaces according to specific embodiments of the invention.

FIG. 6 is an exemplary network diagram illustrating some of the platforms which may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention combine online presence with representations of the emotional or physical state of the user to enable a powerful new way to facilitate communication among a community of users in a network. These emotional or physical states, referred to herein collectively as “moods,” may include virtually any such state which can be experienced by a human. For example, common emotional states which may be represented in various implementations of the invention include happiness, contentment, excitement, indifference, anger, sadness, frustration, etc. In addition, common physical states which may be represented include, for example, hunger, fatigue, illness, etc. According to specific embodiments of the present invention, mood and presence are conflated in a single visual indicator referred to herein as an “online presence indicator” or “OPI” which is used to simultaneously represent both the user's online status and mood to other users in a network.

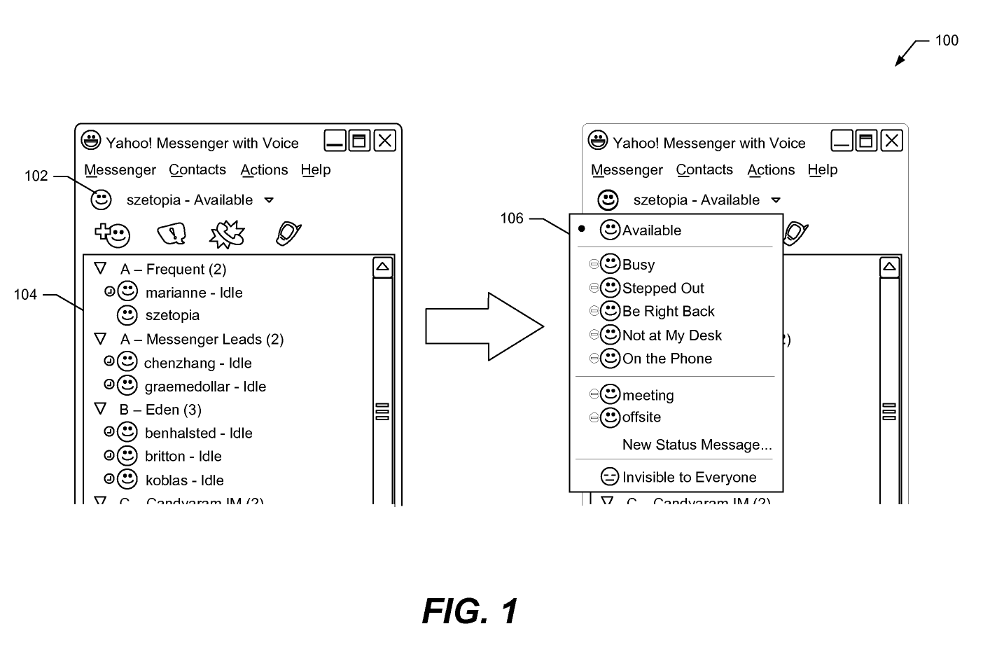

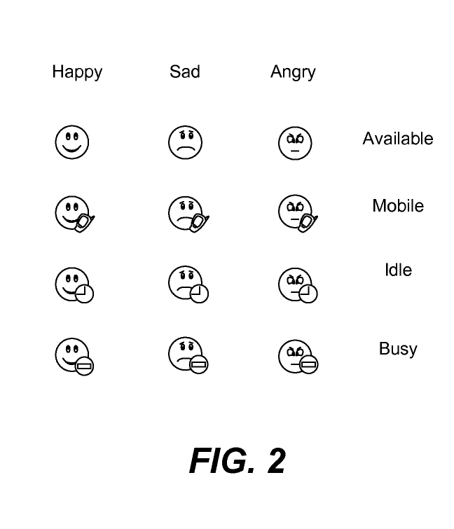

According to some embodiments, presence and mood are represented using variations of a “smiley face,” also referred to herein as “emoticons,” having different facial expressions as illustrated in FIG. 2. In the exemplary context of Yahoo! Messenger, any of the emoticons of FIG. 2 could be substituted for icon 102 in the Messenger interface of FIG. 1 to simultaneously communicate online status and mood. As shown in FIG. 2, the user can be “Available” and simultaneously either “Happy,” “Sad,” or “Angry.” According to a particular embodiment, mood is not reflected in the OPI when the user is offline.

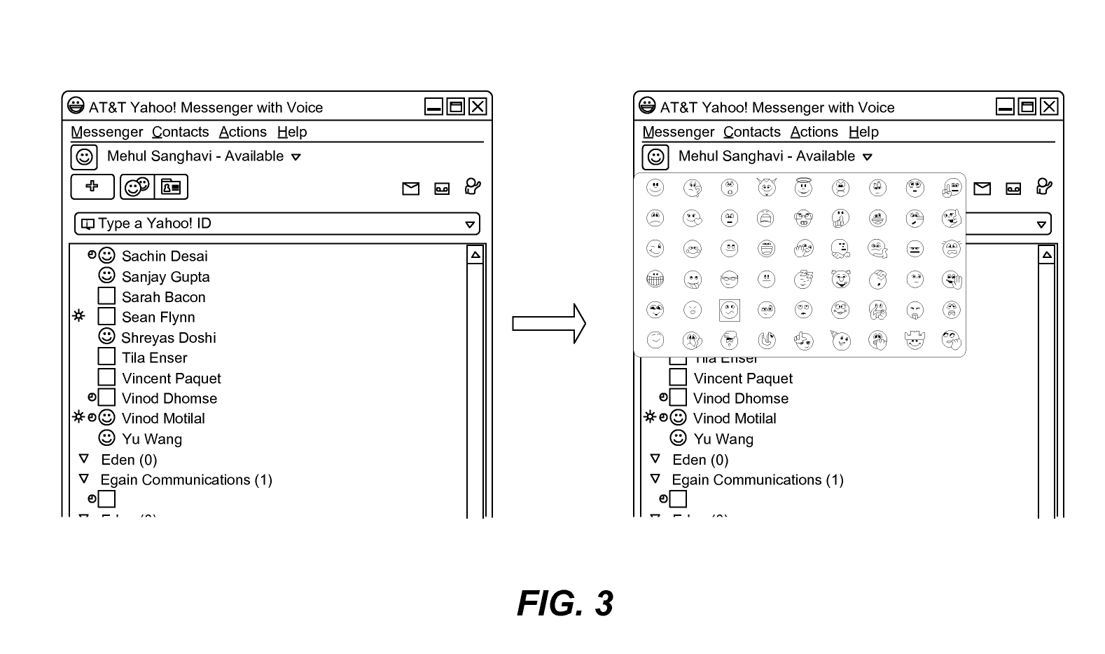

According to various specific embodiments, the OPI and the associated mood may be selected in a variety of ways. For example, in the Yahoo! Messenger interface, the status control menu (e.g., menu 106 of FIG. 1) may be augmented to include the different moods for each of the available options. Alternatively, as shown in FIG. 3, a separate control and/or menu may be provided which enables mood selection. This separate control or menu could be accessed, for example, as a nested submenu from the status control menu, or by selecting the OPI itself (as opposed to the status control).

According to an embodiment in which the OPI status controls reside at the top level of the interface (see U.S. patent application Ser. No. 11/394,034 filed on Mar. 29, 2006 (Attorney Docket No. YAH1P005), incorporated herein by reference in its entirety), different mood options for a given online status could be presented when, for example, the user moves the cursor over one or more of the top level controls. It will be understood that the controls and menus with which online status and mood can be selected may vary considerably without departing from the scope of the present invention.

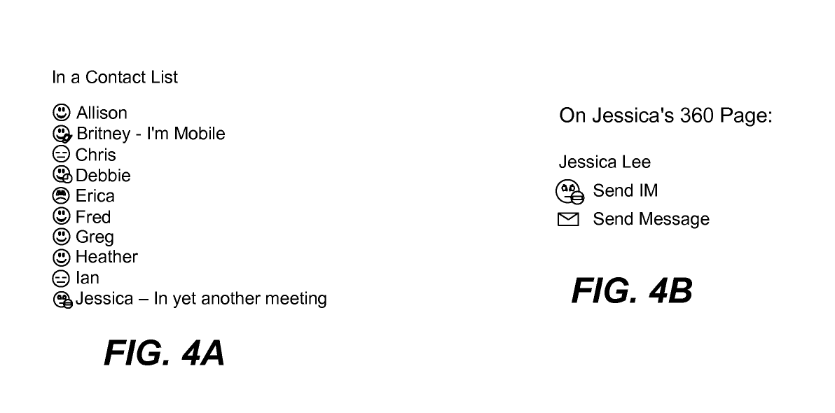

Once an OPI with an associated mood is selected, both the online status and the mood of the user are communicated to other users in the network. That is, the user's online status and mood may be represented by the selected OPI in any application or site on the network in which an OPI is employed. For example, as shown in FIG. 4A, the mood-enhanced OPI may be presented in the Messenger contact list of another user. Alternatively, the OPI may be presented in a web page associated with the user to which other users have access, e.g., a Yahoo! 360 page (see FIG. 4B) or a Yahoo! Groups page (not shown). And because users are typically more actively engaged with the management of their OPIs (as opposed to their avatars), the associated moods are much more likely to accurately reflect the current mood of the corresponding users.

Embodiments of the invention are to be contrasted with previous techniques which communicate mood in that none of these techniques are also able to indicate a user's online status, e.g., online vs. offline, in an integrated way. Similarly, none of the previous mechanisms for indicating online status are also able to represent a user's mood. Even the use of Yahoo! avatars in place of the conventional OPI, e.g., in Yahoo! Messenger, does not perform this function in that the avatar remains unchanged regardless of the user's online status.

According to some embodiments, a standardized and simple representation of the OPI is provided which makes it easy to determine both online status and mood with only a cursory visual inspection. For example, according to one embodiment, only yellow and grey emoticons are used in an effort to make it very clear, regardless of the mood being expressed, whether the corresponding user is online (yellow) or offline (grey). In addition, given the nature of the emoticons employed in such embodiments, mood is readily discernible even in small, low resolution images.

According to an even more specific embodiment, mood is only represented when the user is online. If the user is offline, no mood is indicated, e.g., as illustrated by the grey sleepy face. This reduces any confusion which may result from communicating a mood while a user is offline. However, embodiments are contemplated where mood may be integrated with the offline OPI representation.

According to some embodiments, the simpler and more standardized OPI is facilitated, at least in part, by an intentional segregation of online presence and online identity. This segregation enables standardization in that it removes other aspects of personalization which could otherwise make the OPI more complex. However, it should be noted that more complex embodiments are contemplated in which additional characteristics may be integrated with the OPI. For example, gender could be readily incorporated into the OPI of the present invention, e.g., with hairstyles. Additionally, emoticons may incorporate different colors to indicate a wide variety of characteristics (e.g., political affiliation, personality type, ethnicity, etc.). Thus, while it may be desirable in some implementations to keep the number of online states small (i.e., by limiting the number of characteristics represented in the OPI), the present invention contemplates more complicated schemes. As will be understood, various additional characteristics which may be represented in an OPI, and the various ways in which they may be represented will be apparent to those of skill in the art and are therefore within the scope of the invention.

According to a specific embodiment, users are enabled to generate their own text to go with existing moods. For example, by selecting the “New Status Message” option in the status control menu of the Yahoo! Messenger interface (e.g., menu 106 of FIG. 1), the user is presented with a text box in which he can enter an appropriate description. See for example, the text associated with the user “Jessica” in FIG. 4A.

According to some embodiments, users may also be enabled to create representations of new moods by, for example, manipulating a set of primitives within the standardized context of the OPI. For example, a user may be presented with a palette of facial characteristics from which a facial expression may be constructed on the standard yellow circle on which emoticons are based.

It should be noted that integrating presence and mood in an OPI may be particularly beneficial in mobile applications for which it is highly desirable to minimize the amount of information transmitted to and/or stored on mobile devices. By combining presence and mood, the mood of a user may be communicated to others in the network with very little additional information, particularly where the representations of mood are standardized and relatively easy to represent (e.g., emoticons). For example, a relatively small number of emoticons representing different moods or emotional states may be stored on a mobile device such that the information received from the network need only encode the appropriate emoticon with a small number of bits. This may again be contrasted with the use of avatars, particularly those with animation, which, due to the amount of data required to encode them, would consume an undesirable amount of network or device processing bandwidth in the mobile context.

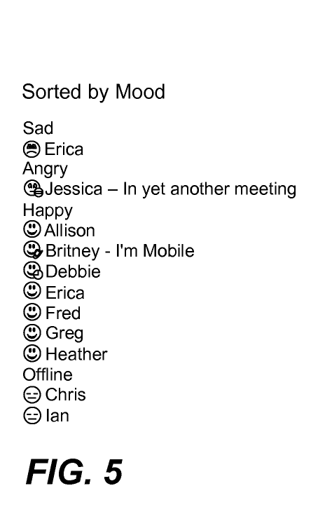

The conflation of presence and mood enabled by the present invention lends itself to a wide variety of applications. As shown above in FIG. 4A, presence and mood may be simultaneously represented in a contact list. According to a more specific embodiment, contact list entries may be sorted or filtered by mood. For example, as shown in FIG. 5, a user can easily identify which of his contacts are sad, happy, angry, etc. This provides an excellent opportunity to start a conversation with particular contacts, i.e., to find out what is wrong or attempt to console.

According to another set of embodiments, a user's experience in a network or online context may be influenced by his current mood. That is, for example, the operation of an application or service with which the user is interacting may be influenced in response to the user's mood as communicated in the network by an OPI implemented according to the invention. For example, the musical selections of a streaming music service, e.g., Yahoo!'s LAUNCHcast radio, can be influenced by the user's current mood, e.g., if the user's mood is “angry,” musical selections might tend toward more soothing fare. In addition, the content presented to the user, e.g., online advertisements, in any of a variety of contexts might change according to the user's mood.

Other exemplary embodiments employ the user's mood to change the theme, background colors (e.g., using CSS), etc., for any content or interface. Appropriate environments for particular applications or services (e.g., Yahoo! Messenger) could be preloaded based on mood. The stationery in an email interface could be changed in response to mood. Blogs written during a particular mood could be tagged with the user's mood. Chatrooms where users of a particular mood are chatting could be bubbled up and presented to users having similar or complementary moods. More generally, a user's mood can be used to influence the user's experience when interacting with a device or network in virtually any way and remain within the scope of the invention.

In other embodiments, moods are aggregated over groups of users for a variety of purposes. In one such embodiment, moods are “averaged” over a user group, e.g., Yahoo! users or some subset of Yahoo! users such as the members of a particular Yahoo! Group. For example, each mood could be assigned a value along a linear continuum or in a “mood vector space,” and the value or vectors could be combined in some way to yield an overall mood for the group. In a more specific embodiment, a user is able to specifically identify the group for which a measure of the aggregate mood is desirable, e.g., friends, family, etc. The user could then track the aggregate mood for his own purposes.

The mood of a specific user or group of users may also be tracked over time to develop a mood profile, or to augment user or group profile data already being collected. Thus, a user's reported moods or mood fluctuations could become part of the user's profile which may be used for any of the purposes for which user profiles are generated.

According to yet another set of embodiments, a variety of techniques are provided for communicating changes to a user's mood, online presence, or other changes or events relating to the user to others in the network. According to one such technique, the OPI “pulses” in a first user's interface to indicate something new or an event has occurred relating to a second user corresponding to that OPI. That is, the visual representation of the OPI alternately fades out and becomes more visible over time to indicate the event or change. It will be understood that this example of “pulsing” is not restrictive, and that a variety of dynamic animations of the OPI may be used to indicate such a change or event.

In addition, the change or event which triggers such an indication may vary considerably according to the invention. For example, this feature could indicate that the user corresponding to the OPI sent or would like to send something to the notified user such as, for example, a message, a voice mail, an add request, a file transfer, etc. Alternatively, the notification could represent a change in mood or online presence for the user corresponding to the OPI.

According to one approach, the user to whom the event or change is communicated may have elected to have events or changes relating to the other user communicated in this way. Alternatively, the user to whom the OPI corresponds may have made the election. According to another similar embodiment, such changes and events relating to one user may be used to trigger alternative communications or notifications to another user regarding the change or event, e.g., email, instant message, voice mail, etc.

According to a particular implementation, a more interactive embodiment is contemplated. According to this implementation, the user to whom the online presence and mood of another user is communicated may take steps to attempt to alter the mood of the other user by effectively sending or suggesting a mood change. According to one embodiment, this feature may be implemented as an extension to the conventional use of an emoticon in an email or instant message. That is, it is common for users to include emoticons in a message for the purpose of cheering up or commiserating with another user. To extend this notion, the present invention makes it possible to include an emoticon in such a message which, when selected by the recipient, may be used to replace the current mood indicated by the recipient's OPI. So, for example, a user can propose a positive mood change to a sad or angry user in an instant message, which can then be accepted by the recipient, resulting in a corresponding change to the OPI.

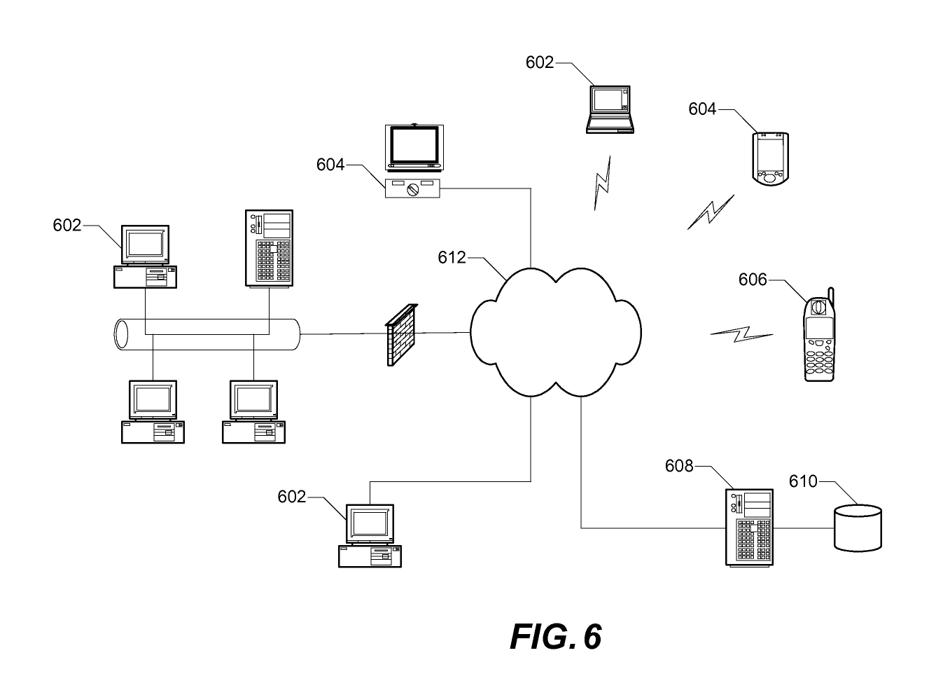

It should be noted that the present invention may be implemented on any computing platform and in any network topology in which communicating online presence is a useful functionality. For example and as illustrated in FIG. 6, implementations are contemplated in which the OPIs and status controls described herein are provided on personal computers 602, media computing platforms 603 (e.g., gaming platforms, or cable and satellite set top boxes with navigation and recording capabilities), handheld computing devices (e.g., PDAs) 604, cell phones 606, or any other type of portable communication platform. Such OPIs and the related status controls may be resident on such devices, e.g., as part of a browser or other application, or be served up from a remote site, e.g., in a Web page, (represented by server 608 and data store 610). The invention may also be practiced in a wide variety of network environments (represented by network 612), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described herein with reference to particular graphical representations of emoticons. However, it will be understood that these representations are merely exemplary, and that any visual representation which can simultaneously communicate online status and mood is within the scope of the invention. For example, emoticons constructed from ASCII characters (i.e., the original emoticons) may be employed.

Alternatively, mood may be represented in an OPI without using a representation of a facial expression. For example, color may be used as a proxy for mood. Other variations will be apparent to those of skill in the art and are within the scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for communicating an online presence of a first user in a network, comprising:
presenting an online presence indicator in a first interface associated with the first user, the online presence indicator representing an online status of the first user as being online or offline, the online presence indicator further representing a mood of the first user;
providing at least one control in the first interface which is operable by the first user to select the online status represented by the online presence indicator, the at least one control further being operable by the first user to select the mood represented by the online presence indicator; and
presenting the online presence indicator of the first user to other users in the network.

2. The method of claim 1 wherein the online presence indicator comprises a representation of a face, and wherein the mood is represented by a facial expression associated with the face.

3. The method of claim 1 wherein the online presence indicator has at least one characteristic associated therewith which represents the online status, and wherein the at least one characteristic does not change with the mood.

4. The method of claim 1 wherein the mood is not represented by the online presence indicator when the online status of the user is offline.

5. The method of claim 1 wherein the first interface is associated with a messaging service, the method further comprising presenting the online status indicator in a second interface associated with a second user in the network, wherein the second interface is associated with either of the messaging service or an application in the network which is separate from the messaging service.

6. The method of claim 1 wherein providing at least one control comprises providing a first control operable to select the online status, and a second control operable to select the mood.

7. The method of claim 1 wherein providing at least one control comprises providing a single control operable to simultaneously select the online status and the mood.

8. The method of claim 1 further comprising influencing operation of an application in the network with which the first user is interacting in response to the mood.

9. The method of claim 1 wherein the at least one control is operable to select the mood from among a plurality of moods, the method further comprising enabling the user to create a representation of a new mood not represented in the plurality of moods.

10. The method of claim 1 further comprising generating a notification to a second user in response to the first user changing the mood.

11. The method of claim 10 wherein generating the notification comprises one of sending a message to the second user, and presenting an animation of the online presence indicator to the second user.

12. A network comprising at least one network device which is operable to:
present an online presence indicator in a first interface associated with a first user in the network, the online presence indicator representing an online status of the first user as being online or offline, the online presence indicator further representing a mood of the first user;
provide at least one control in the first interface which is operable by the first user to select the online status represented by the online presence indicator, the at least one control further being operable by the first user to select the mood represented by the online presence indicator; and
present the online presence indicator of the first user to other users in the network.

13. The network of claim 12 wherein the online presence indicator comprises a representation of a face, and wherein the mood is represented by a facial expression associated with the face.

14. The network of claim 12 wherein the first interface is associated with a messaging service operating in the network, the at least one network device further being operable to present the online status indicator in a second interface associated with a second user in the network, the second interface being associated with either of the messaging service or an application in the network which is separate from the messaging service.

15. The network of claim 12 wherein the at least one network device is further operable to influence operation of an application in the network with which the first user is interacting in response to the mood.

16. The network of claim 12 wherein the at least one network device is further operable to generate a notification to a second user in response to the first user changing the mood.

17. A device with which a first user may communicate with other users in a network, the device comprising a display, a processor, memory having computer-program instructions stored therein, and an interface to the network, the processor being operable in conjunction with the computer program instructions to:
present an online presence indicator in a first interface associated with the first user, the online presence indicator representing an online status of the first user as being online or offline, the online presence indicator further representing a mood of the first user;
provide at least one control in the first interface which is operable by the first user to select the online status represented by the online presence indicator, the at least one control further being operable by the first user to select the mood represented by the online presence indicator; and
communicate the online presence indicator to the network for presentation to other users.

18. The device of claim 17 wherein the online presence indicator comprises a representation of a face, and wherein the mood is represented by a facial expression associated with the face.

19. The device of claim 17 wherein the first interface is associated with a messaging service operating in the network, the processor further being operable in conjunction with the computer program instructions to present a second online status indicator associated with a second user in the network in the first interface, the second interface being associated with either of the messaging service or an application in the network which is separate from the messaging service.

20. The device of claim 17 wherein the processor is further operable in conjunction with the computer program instructions to influence operation of an application with which the first user is interacting in response to the mood.
